(19) United States
(12) Patent Application Publication
(10) Pub. No.: US 2019/0353484 A1
(43) Pub. Date: Nov. 21, 2019

(54) METHODS AND APPARATUSES FOR DETERMINING ATTITUDE INFORMATION FROM STARS USING COLOR INFORMATION

(71) Applicant: GOVERNMENT OF THE UNITED STATES OF AMERICA, AS REPRESENTED BY THE SECRETARY OF THE NAVY, Arlington, VA (US)

(72) Inventors: Chi C. Cheung, Washington, DC (US); Marc Christopherson, Berwyn Heights, MD (US)

(21) Appl. No.: 16/283,377

(22) Filed: Feb. 22, 2019

Related U.S. Application Data
(60) Provisional application No. 62/633,743, filed on Feb. 22, 2018.

(51) Int. Cl. G01C 21/02; G06T 7/70; G06T 7/20; H04N 5/225

(52) U.S. Cl. CPC G01C 21/025; G06T 7/70; G06T 7/20; G06T 2207/10024; H04N 5/2258; G06T 2207/10048; H04N 5/2253

(57) ABSTRACT

Methods and apparatuses for determining attitude information are provided. Light from a plurality of objects within a field-of-view of an image sensor is received. A plurality of images of the objects within the field-of view of the image sensor respectively corresponding to red, green, and blue wavelength ranges are generated. One or more stars within the field-of-view of the image sensors are identified from a total image comprised the plurality of images and one or more images of the plurality of images. Attitude information of the star tracker is determined based on the one or more identified stars. The plurality of images are generated by a triple layer photodetector.

### BACKGROUND

### Field of the Invention

The present application relates generally to methods and apparatuses for determining attitude information from stars using color information.

### Description of Related Art

Since the earliest days of human navigation, people have been using the stars to determine their location. Satellites also use the stars for navigation for attitude knowledge, i.e., the direction and orientation of the satellite as it orbits. Star trackers use monochrome image sensors (e.g., a CCD sensor or a CMOS sensor) to image a star field pattern within its field-of-view (FOV). The image is readout by a computer which is linked to a star catalog stored on board the star tracker. If the star tracker is making an initial attitude determination, or operating in an emergency mode in which attitude information has been lost, it will apply a star identification algorithm to the recorded image to attempt to identify the stars contained therein and use that information to determine the attitude of the object it is attached to. However, traditional star trackers suffer from a number of deficiencies which are discussed below with reference to FIGS. 1A-3.

FIG. 1A illustrates a spacecraft that includes a star tracker 102 attached thereto. Star tracker 102 orbits an object 100 and is surrounded by a star field 104. FIG. 1B is a hypothetical image of various stars 106₁ . . . 106₁₁ recorded in a region F in FIG. 1A which corresponds to the FOV of the star tracker 102. With eleven stars shown in FIG. 1B, it is likely that a traditional star tracker 102 would be able to identify the stars therein from the monochrome image data recorded by its sensor. However, if the FOV is further reduced to, for example, area A shown in FIG. 1C, problems begin to arise. Area A includes stars 106₉ and 106₁₀. Star 106₁₀ is brighter than star 106₉ as represented by its larger size. However, the distance between stars 106₉ and 106₁₀ is approximately equal to the distance between stars 106₁ and 106₄ in area B. Stars 106₁ and 106₄ have the same brightness as stars 106₁₀ and 106₉, respectively. Under these conditions, where the imaged stars are similarly spaced apart and have similar brightness, the star tracker may be unable to resolve whether the recorded image contains stars 106₁ and 106₄ or stars 106₉ and 106₁₀ from the monochrome image alone. This problem is referred to as the ambiguity problem in the field, and has traditionally been avoided by ensuring that the recorded images contain a large number of stars. For traditional trackers using monochrome sensors, a minimum of three stars is required for successful identification; however, in many instances, three stars may still be ambiguous.

The use of color has been considered with respect to the ambiguity problem, but to date has not be widely adopted due to limitations in traditional image sensors. Two types of image sensors have been explored. The first type are trichroic cameras. Trichroic cameras require multiple detectors that add bulk, weight, and system complexity, with independent noise terms, and thus are low efficiency options in low-light environments (e.g., space) and high-background noise environments (e.g., terrestrial). The second type are conventional CMOS and CCD sensors with a Bayer filter array upstream of the sensor in the optical path. However, these configurations are also problematic, as explained with respect to FIGS. 2A-3.

FIG. 2A illustrates light 206 incident on a plurality of filters 202₁ . . . 202₁₂ of a Bayer filter array. Of course, one of ordinary skill will appreciate that this figure and the figures that follow illustrate a one-dimensional array, but the problems discussed below are equally applicable to a two-dimensional array. Each filter 202ᵢ allows one wavelength range of light to pass: red, green or blue. Filtered light 206 is then incident on a pixel 204₁ . . . 204₁₂ of the sensor array. One problem with this approach is that the image data shifts with color. As shown in FIG. 2B, filtered red light is incident on pixels 204₁, 204₄, 204₇, and 204₁₀, but filtered green light, as shown in FIG. 2C, is incident on a different set of pixels 204₂, 204₅, 204₈, and 204₁₁, and filtered blue light is incident on yet another set of different pixels 204₃, 204₆, 204₉, and 204₁₂, as shown in FIG. 2D. Thus, the image data is shifted in position depending on which wavelength of light is being received. This makes calculating the centroid of the incoming light, which is important for determining the position of the star in the image for the star finding algorithms, difficult. This is illustrated in FIG. 3.

FIG. 3 shows image data 302, 304, and 306, for red, green, and blue light respectively. The centroid of each wavelength range of light is also shown as 308₁, 308₂, and 308₃. As shown in FIG. 3, the centroids are shifted with respect to each other. Thus, a corrective process is necessary to address this issue which leads to slower acquisition times. Another downfall of this design is that the majority of light falls on an unusable portion of the sensor. For example, red light incident on a blue or green filter is blocked and essentially discarded. The effective sensor size is therefore reduced. In a low-light environment, this leads to an increase in noise and requires longer exposure times to compensate. However, star trackers routinely operate in high frame rate modes were large numbers of images are being recorded and analyzed back-to-back to expedite attitude acquisition. Due to the limitations of the Bayer filter approach, that frame rate would have to be limited. Thus, it would be preferable to have a system that can make use of color information for star tracking that overcomes these deficiencies.

### SUMMARY OF THE INVENTION

One or more of the above limitations may be diminished by structures and methods described herein.

In one embodiment, a method of determining attitude information is provided. Light from a plurality of objects within a field-of-view of an image sensor is received. A plurality of images of the objects within the field-of view of the image sensor respectively corresponding to first, second, and third wavelength ranges are generated. One or more stars within the field-of-view of the image sensors are identified from the plurality of images. Attitude information of the star tracker is determined based on the one or more identified stars. The plurality of images are generated by a triple layer photodetector.

### BRIEF DESCRIPTION OF THE DRAWINGS

The teachings claimed and/or described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A is an illustration depicting a star tracker orbiting an object and the star field surrounding the star tracker.

FIG. 1B is an image of stars contained in an area F in FIG. 1A.

FIG. 1C is another image of contained in an area F in FIG. 1A.

FIG. 2A is an image of a traditional Bayer color filter array and corresponding sensor.

FIG. 2B is an image of the filter/sensor of FIG. 2A processing red light.

FIG. 2C is an image of the filter/sensor of FIG. 2A processing green light.

FIG. 2D is an image of the filter/sensor of FIG. 2A processing blue light.

FIG. 3 is an image showing information recorded by the sensor shown in FIGS. 2B-D, and their respective centroids.

FIG. 4 is an illustration explaining the operation of a triple layer photodetector according to one embodiment.

FIG. 5 is a graph illustrating the different absorption profiles of the each layer of a triple layer photodetector according to one embodiment.

FIG. 6 is a graph illustrating the different absorption profiles overlaid with stellar spectra.

FIGS. 7A-B are illustrations showing images produced by the triple layer photodetector in two different regions of space.

FIGS. 8A-B illustrate spectral information contained in a star catalog.

FIG. 9 is a schematic illustration of a star tracker according to one embodiment.

FIG. 10 is a flow chart illustrating the operation of the star tracker depicted in FIG. 9.

Different ones of the Figures may have at least some reference numerals that are the same in order to identify the same components, although a detailed description of each such component may not be provided below with respect to each Figure.

### DETAILED DESCRIPTION OF THE PREFERRED EMBODIMENTS

In accordance with example aspects described herein are methods and apparatuses of determining attitude information from stars using color information.

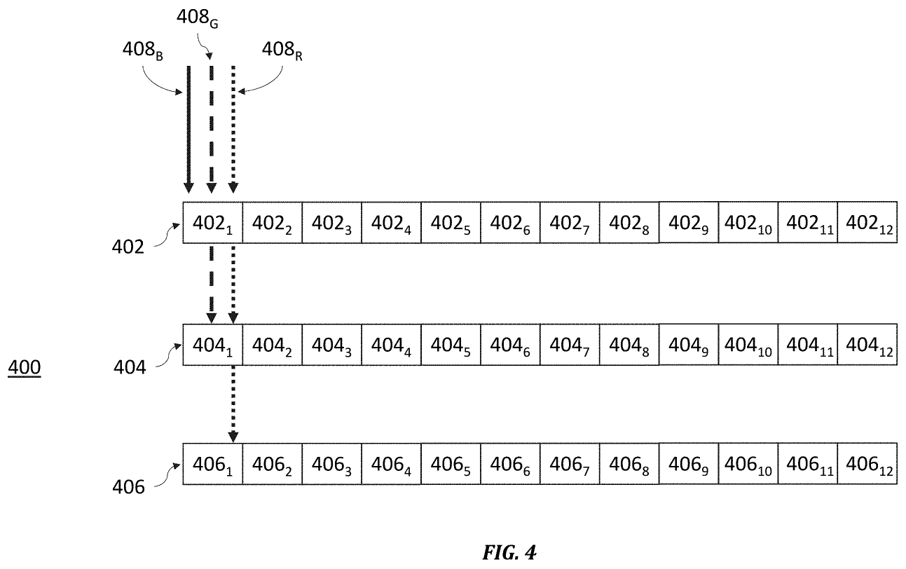

Initially, an exemplary sensor for use in one embodiment will be described. FIG. 4 illustrates the general operation of a triple layer photodetector (TLP) 400. Incident light may be considered to fall within three wavelength ranges: red 408_{R}, green 408_{G}, and blue 408_{B}. It should be noted that the red component may include infrared light and the blue component may include the ultra-violet. Sensor 400 includes, in one embodiment, three layers: layer 402, layer 404, and layer 406. Each of layers 402, 404, and 406 is constructed to preferentially absorb light within a certain wavelength range. Light comprising 408_{R}, 408_{G}, and 408_{B} is incident on an upper layer 402 of sensor 400. Layer 402 is constructed to preferentially absorb blue wavelengths. Light 408_{B} interacts with the material comprising layer 402 and generates free electrons in each of pixels 402₁ . . . 402₁₂, the amount of which directly corresponds to the intensity of light 408_{B} on each pixel. However, the material comprising layer 402 is not constructed to preferentially absorb light 408_{G} and 408_{R}. Thus, some if not most of light 408_{G} and 408_{R} passes through layer 402 without being absorbed. Next, light 408_{G} and 408_{R} are incident on layer 404. Similarly to layer 402, layer 404 is configured to preferentially absorb light 408_{G} in the green wavelength range. Light 408_{G} interacts with the material comprising layer 404 and generates free electrons in pixels 404₁ . . . 404₁₂, the amount of which directly corresponds to the intensity of light 408_{G} on each pixel. Layer 404, however, is not constructed to preferentially absorb light 408_{R}. Accordingly, some if not most of light 408_{R} passes through layer 404 and is incident on layer 406. Layer 406 is constructed to preferentially absorb light 408_{R}, and thus light that has passed through layers 402 and 404 is absorbed by layer 406. More specifically, light passing through layers 402 and 404 and incident on layer 406 generates free electrons within each of the pixels 406₁ . . . 406₁₂ in proportion to the intensity of light 408_{R} that is incident on those pixels 406₁ . . . 406₁₂. One of the advantages of this sensor, is that the centroid of each layer 402, 404, and 406 remains constant. The free electrons generated in each of layers 402, 404, and 406 are readout under control of a processor (e.g., processor 902 described below). More specifically, the voltages generated by the accumulation of electrons in each of the pixels represent an analog signal which is converted to a digital signal by an A/D converter. To obtain the monochrome (i.e., all colors) image data, the image data from layers 402, 404, and 406 are combined.

In one embodiment, sensor 400 may be the Foveon X3 image sensor. A preferred sensor may have a 2652×1768 pixel array with three active layers. The pixels may be 7.8 microns by 7.8 microns in size, leading to an active raster area of 20.68 mm (L)×13.79 mm (W). Each layer 402, 404, and 406 produces an analog signal that is converted into a digital signal by an A/D converter (not shown). In a preferred embodiment, the resulting digital signal is a 12-bit signal.

In another embodiment, a four layer sensor may be used as sensor 400. Each layer of the sensor may be configured to absorb a certain wavelength range of light, while transmitting others. The use of a four layer sensor would allow for an additional color region to be used in the identification process (described below). Having described the construction of sensor 400, attention will now be directed to use of sensor 400 to image stellar objects.

In general, sensor 400 is used to generate monochrome or total (i.e., all colors) image data while simultaneously generating individual color image data. Processor 902, described below, uses the total image data plus image data of at least one color to identify stars, satellites or other objects that are present in the field-of-view. With that information, processor 902 is able to calculate the attitude information. This process will be described in detail below, beginning with the filter profiles corresponding to layers 402, 404, and 406.

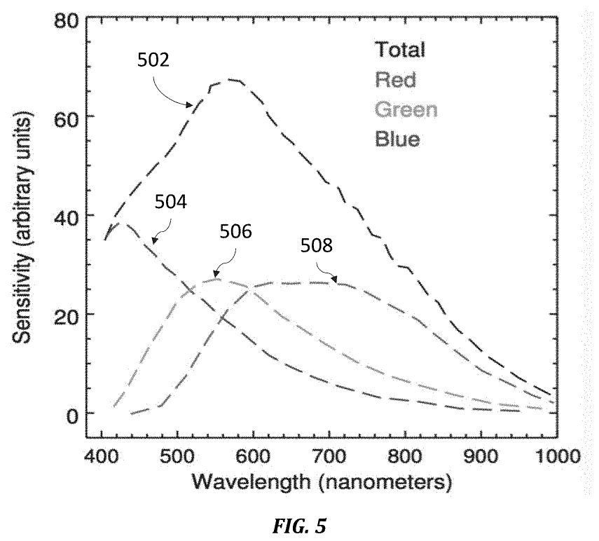

FIG. 5 shows filter profiles 504, 506, and 508 respectively corresponding to the different layers 402, 404, and 406 of the Foveon X3 sensor. FIG. 5 also shows the overall filter profile 502 which is a combination of the individual profiles 504, 506, and 508. Since each layer 402, 404, and 406 is constructed to absorb light within respective wavelength ranges, layers 402, 404, and 406 operate as filters as well as sensors. In this embodiment, it should be noted that layer 402, which preferentially absorbs light 408_{B} also absorbs light 408_{G} and 408_{R}, but to a lower extent especially in the wavelength range of 400-520 nm. Similarly, layer 404, which preferentially absorbs light 408_{G}, also absorbs light 408_{B} and 408_{R}, but again to a lower extent in the wavelength range of 520-600 nm. Finally, layer 406, which preferentially absorbs light 408_{R}, also absorbs light 408_{B} and 408_{G} but again to a lower extent in the wavelength range of 600-1000 nm.

By doping layers 402, 404, and 406 or changing the materials with which they are made, the wavelength ranges over which layers 402, 404, and 406 absorb light may be changed. Thus, the wavelength ranges need not be confined to between the infrared and ultraviolet, rather the absorption ranges may be moved within the electromagnetic spectrum by changing and/or doping the materials constituting layers 402, 404, and 406.

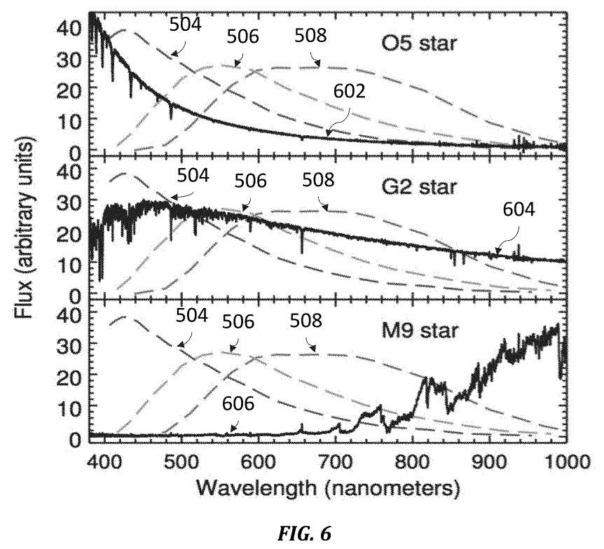

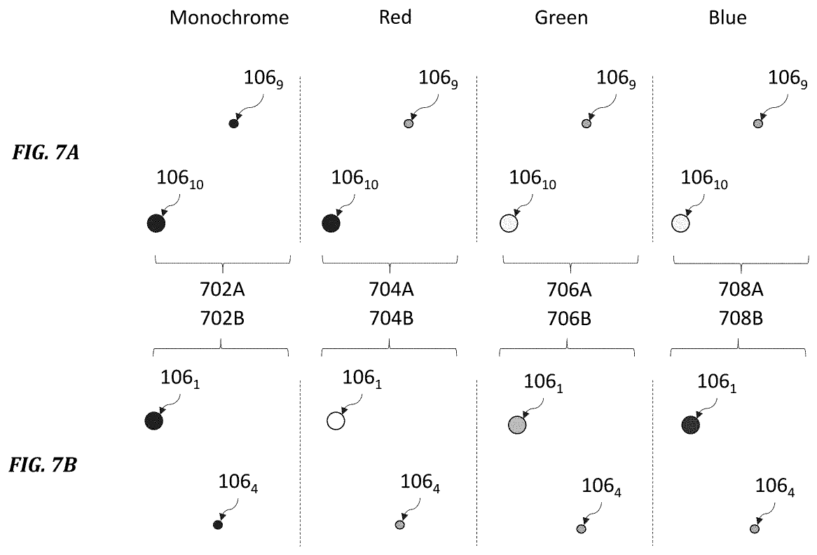

FIG. 6 shows the same filter profiles 504, 506, and 508 overlaid with image spectra from three different stars 602, 604, and 606. As is evident from FIG. 6, an O5 star, a G2 star, and an M9 star have different spectra in the wavelength range of 400-1000 nm. Thus, when light from these types of stars is incident on sensor 400, the response of sensor 400 will be different, as explained in reference to FIGS. 7A and 7B.

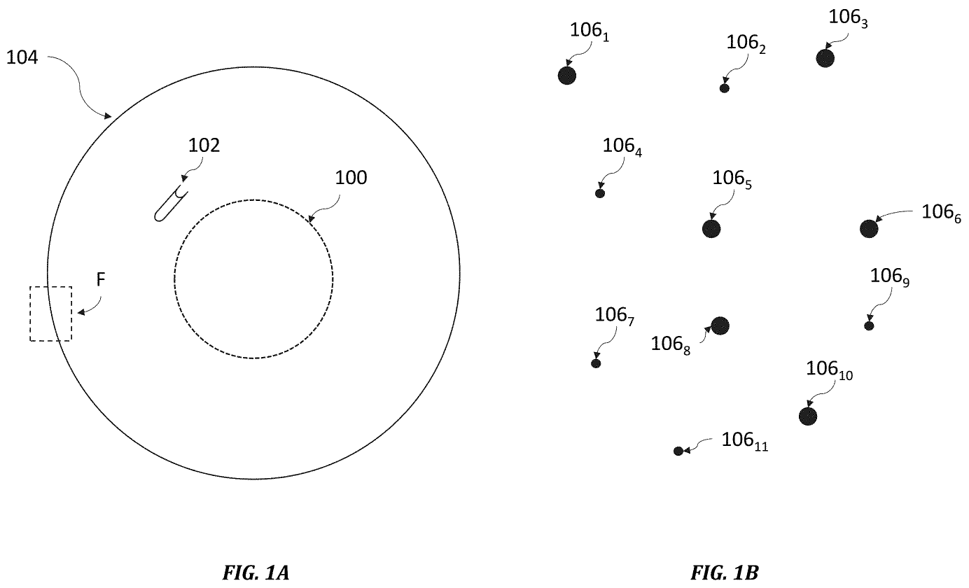

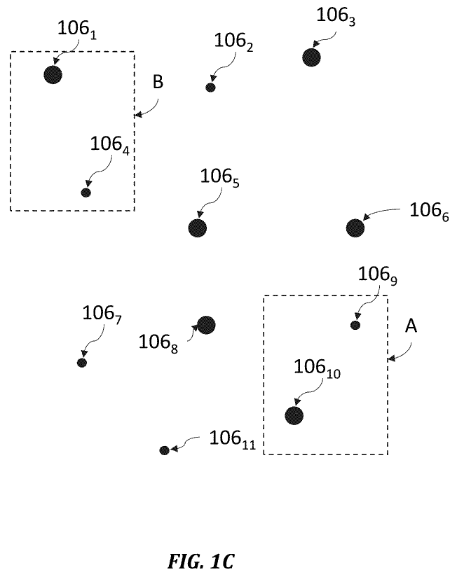

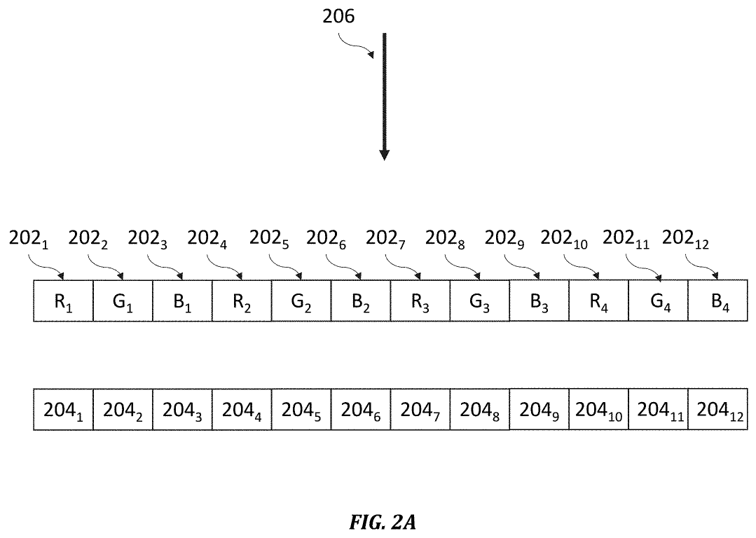

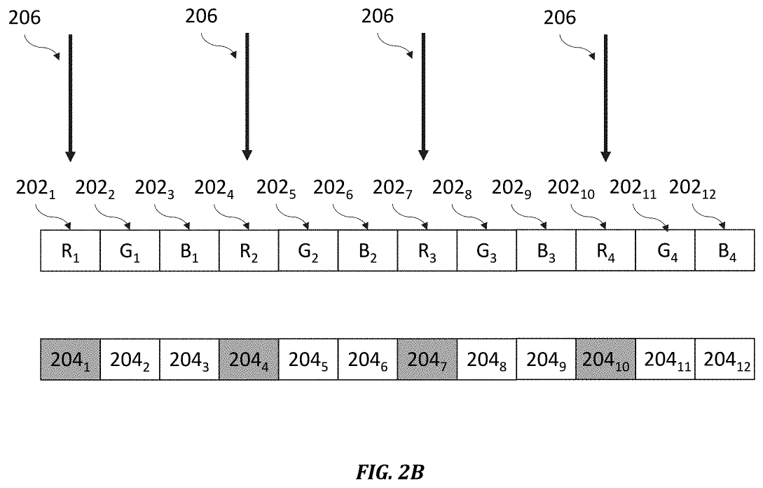

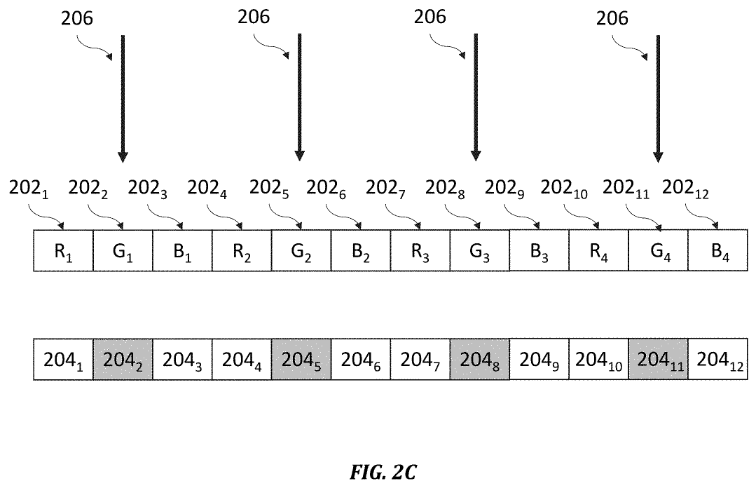

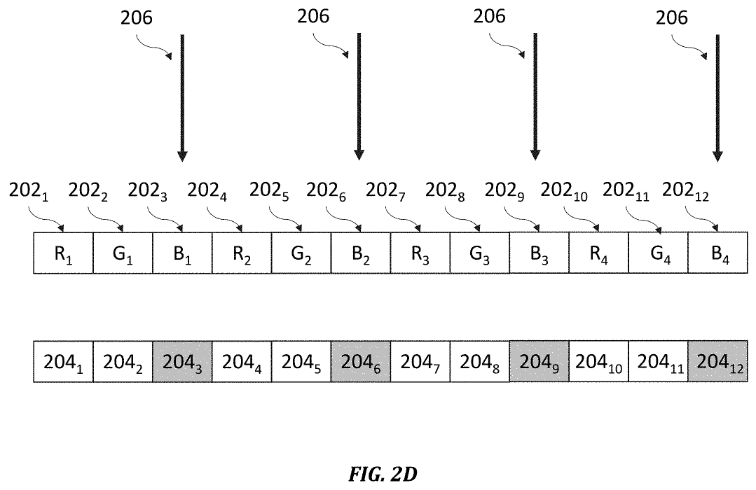

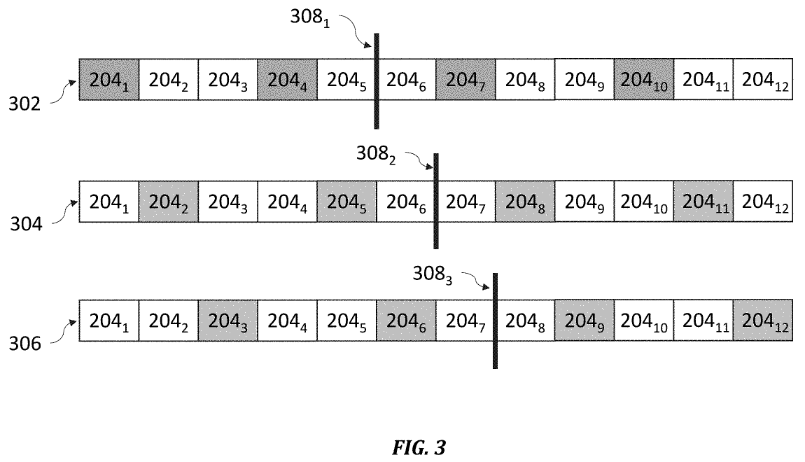

FIG. 7A shows images 702A-708A of stars 106₉ and 106₁₀, and images 702B-708B of stars 106₁ and 106₄ from FIG. 1C. As discussed above, and evident from FIGS. 702A and 702B, if only a monochrome, or total, image is obtained it is difficult, if not impossible, to distinguish the grouping of stars 106₉ and 106₁₀ from stars 106₁ and 106₄, if these stars are the only stars within the FOV of the star tracker. This is because depending on the orientation of the star tracker 102, images 702A and 702B may be indistinguishable. If image 702A were rotated approximately 90 degrees, it would appear nearly identical to image 702B. Thus, a star tracker 900 considering both images would be unable to determine whether the star tracker 900 is imaging a region of space corresponding to area A or B in FIG. 1C. However, by considering color information this ambiguity is resolved.

Image 704A is an image produced by pixels within layer 406 in FIG. 4, corresponding to red-infrared wavelengths. In the example of FIG. 7A, star 106₁₀ is an M9 type star whose spectra predominantly lies in the red to infrared wavelengths of 700-1000 nm. Thus, image 704A shows a strong intensity for star 106₁₀ (denoted by the circle being fully black). However, because an M9 star produces little if any blue or green light, images 706A and 708A show star 106₁₀ with much reduced intensity compared to image 704A. This is reflective of the fact that little light is absorbed by layers 402 and 404 in FIG. 4. Star 106₉ is a G2 type star that has a fairly even distribution of light intensity across the wavelength range of 400-1000 nm, and thus the intensity of star 106₉ in images 704A, 706A, and 708A is fairly constant.

Like image 704A, image 704B is produced by pixels within layer 406 in FIG. 4 when the star tracker 102 is directed to area B in FIG. 1C. However, in image 704B, the intensity of star 106₁ is much reduced compared to the intensity of star 106₁₀ in image 704A. This is a result of the fact that star 106₁ is an O5 type star whose spectra is dominated by blue wavelengths, and to a lesser extent green wavelengths, as shown in FIG. 6. Light from star 106₁ is therefore preferentially absorbed by layers 402 and 404, with little light reaching layer 406. Thus, star 106₁ shows little intensity in image 704B, but greater intensity in images 706B and 708B.

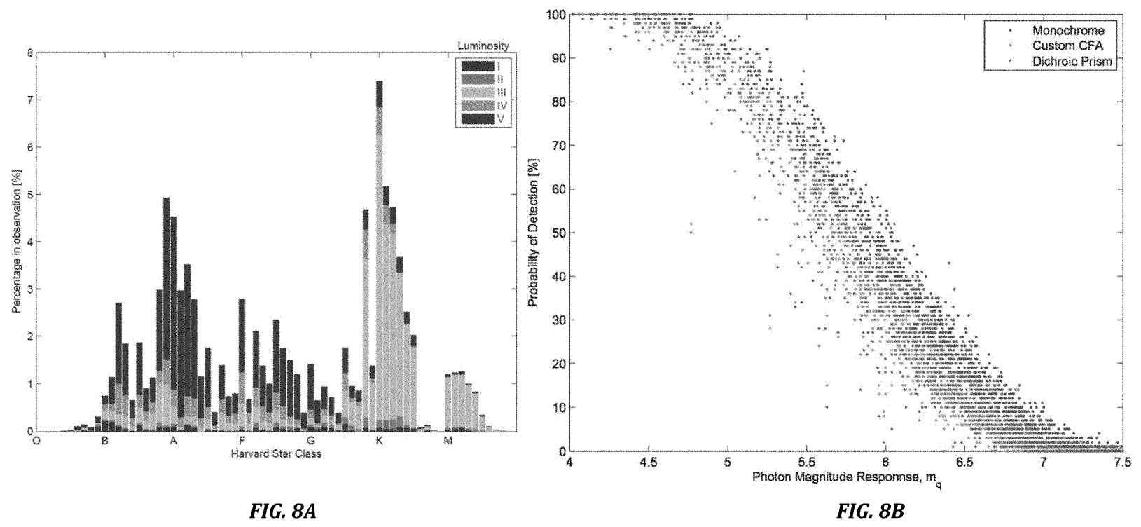

Using the color information from sensor 400, it is now possible to identify stars within a FOV in situations where traditional monochrome imaging, or color filtering using a Bayer filter, would fail. This is because the spectral components of stars within the star catalog are well documented, as evidenced by FIGS. 8A and 8B.

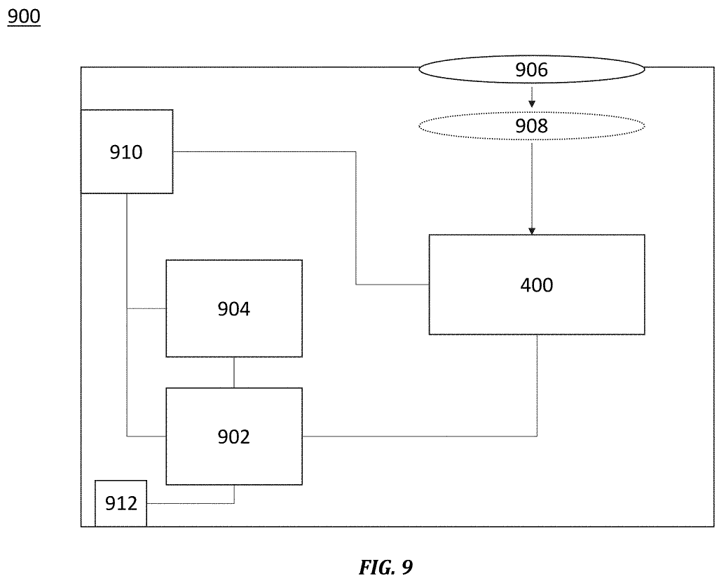

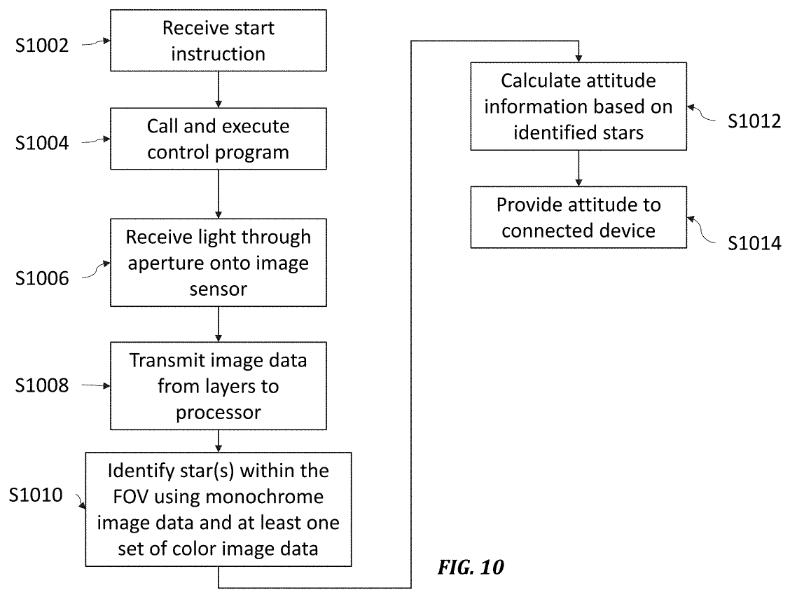

Attention will now be directed to a star tracker 900 that includes sensor 400 and its method of operation, as illustrated in FIGS. 9 and 10. FIG. 9 is a schematic view of a star tracker 900 according to one exemplary embodiment. FIG. 10 is a flow chart illustrating the operation of tracker 900. Star tracker 900 includes a processor 902, memory 904, an aperture 906, preferably imaging optics 908, a power supply 910, and an input/output (I/O) connection 912. Star tracker 900 is configured to receive a start instruction through I/O connection 912 (S1002). The start instruction is provided to processor 902 which calls and executes a control program stored in memory 904 to begin an acquisition operation (S1004). Processor 902 includes an internal crystal-controlled clock that controls the timing of acquisition operation. Memory 904 also includes a star catalog that includes color information each of the stars contained therein. In one embodiment, one or more of the following star catalogs may be stored in memory 904: the Hipparcos catalog, the Tycho and Tycho-2 catalogues, the AAVSO Photometric All-Sky Survey, and the Gaia catalog. In accordance with the start instruction, processor 902 begin an image capture operation using sensor 400 (S1006). Light from a FOV is received through aperture 906 and, in one preferred embodiment, directed to imaging optics 908. Optics 908 focus the received light and direct the same onto sensor 400, whose operation is described above.

In one embodiment, image data from each of the three layers 402, 404, and 406 are sent to processor 902 (S1008). Processor 902 uses the image data from one or more of the three layers 402, 404, and 406 in conjunction with the overall monochrome image (which is a combination of the image data from the three layers 402, 404, and 406) and the spectral information contained in the star catalog stored in memory 904 to identify the stars within the FOV (S1010). Processor 902 may use some or all of the color information from the images corresponding to layers 402, 404, and 406 to identify the stars within the FOV. In one embodiment, an initial identification operation using the overall image data and image data corresponding to just one color may be attempted. For example, the initial identification operation may use the overall image data and the red wavelength image data first. Only in a circumstance where the stars could not be identified after the initial identification are image data from the other layers used. If a successful identification is made, then the image data for the other colors may be discarded. However, in the circumstance where identification failed using the overall image data and the red wavelength image information, processor 902 may repeat the identification operation using monochrome, red, and green image information as well. If that still fails to yield an identification result, then processor 902 may again repeat the identification operation using monochrome, red, green, and blue image information. Of course, the order of which color information is used can be changed such that any order may be used. While the use of the overall image data and image data from only one color may yield a positive identification in the vast majority of circumstances, one may also use two colors in the initial identification operation to even further increase the likelihood of a positive identification and thus further reduce or perhaps eliminate the need to repeat the identification operation if an initial attempt fails.

Returning to the example in FIGS. 7A and 7B, processor 902 may analyze the image data corresponding to image 704A, i.e., the red wavelength range image data, in conjunction with the overall image data and determine that star 106₁₀ is an M9 type star located proximate to a G2 type star (106₉). With this information, processor 902 can immediately rule out area B in FIG. 1C as being the FOV, even though the distances between the two stars are similar. By using the red wavelength image data, the previously indistinguishable groups of stars can now be easily distinguished. While green and blue information may also be considered, in one embodiment if a successful identification is made based on monochrome image information and red wavelength image information, then star tracker generates a result and proceeds to process the next image, as further processing would yield little, if any, additional information and slow the operation of the star tracker overall.

Using the identification information obtained in S1010, and other information (e.g., altitude with respect to a horizon, latitude and longitude, and formulas for Earth orientation as a function of time) that may be received through I/O connection 912, processor 902 calculates the attitude information of star tracker 900 (S1012). Processor 902 then provides the attitude information to a connected device (e.g., a navigation or attitude control system) through I/O connection 912. Once the initial attitude information is acquired, the star tracker 900 may switch to a tracking mode of operation. In the tracking mode, star tracker 900 may only track the brightest stars in the FOV and do so with only monochrome image data so as to lead to faster processing.

While the above described star tracker 900 is ideally suited to use on spacecraft, the invention is not limited thereto. Rather, star tracker 900 may be used in a terrestrial environment either on the land, sea, or air, provided the suitable light sources are visible. Thus, as one of ordinary skill will appreciate, any land, sea, or air device (e.g., a vehicle, ship, airplane, helicopter, or drone, among others) that requires attitude/position information may have star tracker 900 attached thereto or incorporated therein to provide such information. While stars are suitable light sources, satellites may also be favorable light sources in a terrestrial environment as they tend to be bright objects in the sky, especially during the daytime, and their individual orbits are known and tracked across a constant star field.

While various example embodiments of the invention have been described above, it should be understood that they have been presented by way of example, and not limitation. It is apparent to persons skilled in the relevant art(s) that various changes in form and detail can be made therein. Thus, the disclosure should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. An apparatus for identifying objects within a field-of-view of the apparatus, comprising:
a processor;
memory connected to the processor and storing at least one control program and at least one star catalog; and
an optical sensor configured to receive light from a field-of-view of the apparatus, wherein the optical sensor includes:
a first semiconductor layer constructed to absorb light within a first wavelength range,
a second semiconductor layer constructed to absorb light within a second wavelength range, and
a third semiconductor layer constructed to absorb light within a third wavelength range,
wherein the optical sensor is constructed to output image data generated by the first, second, and third semiconductor layers, and
wherein the processor is configured to identify one or more light sources within the field-of-view of the apparatus based on (i) total image data comprising the image data generated from the first, second, and third semiconductor layers, (ii) image data generated from one of the first, second, and third semiconductor layers, and (iii) information on objects stored in the at least one star catalog.

2. The apparatus according to claim 1, wherein the processor is further configured to determine attitude information of the apparatus based on the one or more identified light sources.

3. The apparatus according to claim 1, wherein the first wavelength range comprises infrared light and red light.

4. The apparatus according to claim 3, wherein the second wavelength range comprises green light.

5. The apparatus according to claim 4, wherein the third wavelength range comprises ultraviolet light and blue light.

6. The apparatus according to claim 1, further comprising:
imaging optics configured to direct light from the field-of-view of the apparatus onto the optical sensor.

7. A method of identifying objects within a field-of-view of an apparatus, comprising:
receiving, by an optical sensor, light from a field-of-view of the apparatus, wherein the optical sensor includes:
a first semiconductor layer constructed to absorb light within a first wavelength range,
a second semiconductor layer constructed to absorb light within a second wavelength range, and
a third semiconductor layer constructed to absorb light within a third wavelength range,
outputting, from the optical sensor, image data generated by the first, second, and third semiconductor layers, and
identifying, by a processor, one or more light sources within the field-of-view of the apparatus based on (i) total image data comprising the image data generated from the first, second, and third semiconductor layers, (ii) image data generated from one of the first, second, and third semiconductor layers, and (iii) information on objects from at least one star catalog stored in memory that is connected to the processor.

8. The method according to claim 7, further comprising:
determining, by the processor, attitude information of the apparatus based on the one or more identified light sources.

9. The method according to claim 7, wherein the first wavelength range comprises infrared light and red light.

10. The method according to claim 9, wherein the second wavelength range comprises green light.

11. The method according to claim 10, wherein the third wavelength range comprises ultraviolet light and blue light.

12. The method according to claim 7, wherein imaging optics direct light from the field-of-view of the apparatus onto the optical sensor in the receiving step.

13. The method according to claim 7, wherein the first, second, and third wavelength ranges are selected to substantially match first, second, and third filter profiles used to generate the information on the stellar objects in the at least one star catalog.

14. The method according to claim 7, wherein the field-of-view includes a star, and the light received from the field-of-view includes light from the star.

15. The method according to claim 7, wherein the field-of-view includes a satellite, and the light received from the field-of-view includes lights from the satellite.

16. The method according to claim 7, wherein the optical sensor receives the light from the field-of-view, in the receiving step, while attached to an object that is located on land, on the sea, in air, or in space.

17. A method of determining attitude information of a star tracker, comprising:
receiving light from a plurality of objects within a field-of-view of an image sensor;
generating a plurality of images of the objects within the field-of view of the image sensor respectively corresponding to red, green, and blue wavelength ranges;
identifying one or more stars within the field-of-view of the image sensor from a total image formed from the plurality of images and one of the plurality of images; and
determining attitude information of the star tracker based on the one or more stars identified in the identifying step,
wherein the plurality of images are generated by a triple layer photodetector.
